(19) United States
(12) Patent Application Publication
(10) Pub. No.: US 2026/0181004 A1
(43) Pub. Date: Jun. 25, 2026

(54) PATTERN OF LIFE DYNAMIC MONITORING OF CONNECTIONS

(71) Applicant: Darktrace Holdings Limited, Cambridge (GB)

(72) Inventors: Guy Howlett, Lavenham (GB); Jack Stockdale, Cambridge (GB)

(21) Appl. No.: 19/426,901

(22) Filed: Dec. 19, 2025

Related U.S. Application Data
(60) Provisional application No. 63/736,488, filed on Dec. 19, 2024.

(51) Int. Cl. H04L 9/40

(52) U.S. Cl. CPC H04L 63/1425; H04L 63/0263

(57) ABSTRACT

According to one embodiment, a cyber threat detection system is described. The cyber threat detection system features a pattern-of-life (POL) model and connection analytic logic. The POL model is configured to conduct analyses on information associated with a connection to determine whether the connection is anomalous. The connection analytic logic is configured to identify whether the connection has been previously evaluated, route the connection information to the POL model for processing. Herein, the connection analytic logic is further configured to disable or disconnect the connection in response to a classification score, generated by the POL model, represents that the connection is anomalous.

### RELATED APPLICATION

This application claims priority under 35 USC § 119 to U.S. Provisional Patent Application No. 63/736,488, entitled “CYBERSECURITY COMPONENTS” filed on Dec. 19, 2024, where the entire content of this application is incorporated herein by reference in its entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments of a cyber security system, such as a cyber security appliance and/or cloud-based cyber security analytics to identify anomalous network connectivity based on pattern-of-life (POL) modeling.

### BACKGROUND

Cyber security attacks have become a pervasive problem for an enterprise (e.g., any organization including a company, a corporation, or a partnership; an individual or group of individuals, etc.) as enterprise networks and their networking devices are too frequently subjected to attack and compromise. A “cyber security threat” (sometimes referred to as a “cyber threat”) constitutes a threat to the security of a network and/or networking devices, such as an enterprise network providing anomalous interconnectivity to one or more networking devices. The cyber threat may originate from an external endpoint computing device or an internal entity (e.g., a negligent or unauthorized, rogue user), which may be generally referred to as a “threat actor.” Also, cyber threats may represent malicious or criminal activity from a threat actor, ranging from theft of credential to even a nation-state attack. For example, the cyber threat may be a cyber-attack against a network and/or a networking device via an anomalous connection. This cyber-attack may involve malicious software introduced into a computing device or into the network.

The migration to the cloud and reliance toward on-premises networks has marked an extraordinary transformation for many enterprises, and more often than not, a monumental undertaking in providing cloud-based and/or network-based security for an enterprise. While native approaches have facilitated detection of potential cyber threats, these approaches fail to significantly reduce an enterprise's exposure to data loss caused by anomalous behavior by a malicious source through early detection of anomalous activity and early notification of the potential cyber threat to a network security team. Existing solutions fall short in providing the necessary level of visibility for those network security teams who understand the enterprise network, but the cyber security system has difficulties in detecting anomalous connections by threat actors to a network. Also, obtaining metrics associated with a connection to a network for use in comparison to expected or normal behaviors of the persons or groups of persons associated with networking devices access to a network under surveillance—pattern of life (POL)—is a core feature in securing an enterprise that has not been utilized.

### SUMMARY

Embodiments of connection analytic logic, namely components operating as part of an endpoint computing system, cyber security appliance, and/or scalable cloud platform for example, are described. According to one embodiment of the disclosure, operating with a classifier and pattern-of-life (POL) models, the connection analytic logic is configured to identify anomalous network connectivity by at least (i) monitoring connections over which information is propagated, (ii) leveraging operability of a classifier and pattern-of-life (POL) model(s) to conduct analytics on a monitored connection, and (iii) prompting disablement of the monitored connection in response to determining this connection is associated with a cyber threat such as anomalous activity by a potential threat actor. The determination of the monitored connection being associated with a cyber threat may be achieved when (a) the classifier and POL model(s) return a value that identifies the likelihood of the monitored connection being associated with anomalous activity exceeds a prescribed threshold (e.g., exceeding a preset anomaly percentage, etc.) or (b) an operational limit for the monitored connection has been exceeded. Examples of operational limits may include, but is not limited or restricted to a specific throughput limit (e.g., data upload/download threshold), a bandwidth limit (e.g., data transfer threshold rate), a number (or percentage) of query response messages from the connection analytic logic that have returned a “negative” classification score or the like.

More specifically, according to one embodiment of the disclosure, the connection analytic logic (CAL) includes pattern-of-life (POL) decision logic and POL connection tracker logic. The POL decision logic is configured to receive information associated with a connection (hereinafter, “connection information”) from a parser implemented as part of a networking device to receive data traffic and extract the connection information therefrom. The connection information may include network connection data (e.g., IP address(es), port number(s), protocol, etc.). The networking device may include an endpoint computing device deployed within an enterprise network, a cloud-based server deployed within a scalable cloud platform, or the like.

The POL decision logic is further configured to determine if the connection has been previously evaluated (e.g., determine whether the connection information has already been part of an attempted cyber threat). If no previous evaluation has occurred, the POL decision logic provides the connection information to one or more classifiers (hereinafter, “classifier(s)”) operating in concert with one or more POL models (hereinafter, “POL model(s)”), which are configured to analyze the connection information, which may be translated into embedding data, against metrics that represent normal (or expected) connections by an entity, namely a person and/or his/her device or a group of persons (or their devices) to/from which the connection information pertains.

More specifically, the POL model(s) are configured to conduct analytics on the connection information to return embedding data that includes a classification score, namely an identifier as to the likelihood of the monitored connection is associated with a cyber threat (e.g., anomalous activity such as unusual login patterns or unexpected data transfers by a threat actor, abnormal system behavior caused by the threat actor, malicious activity such as privilege escalation attempts or phishing campaign, etc.). The classification score may be set to a first prescribed value or range of values (hereinafter, “negative classification score”) in response to the POL model(s) detecting the connection deviates from its normal (or expected) connection metrics. Alternatively, the classification score may be set to a second prescribed value or range of values (hereinafter, “positive classification score”) in response to the POL model(s) detecting the connection is consistent with normal (or expected) connection metrics, and thus, does not appear to be associated with a cyber threat.

The POL connection tracker logic is configured to receive the classification score from the classifier(s) and maintain state information associated with the connections under evaluation. The state information may include metrics inclusive of properties of the connection and/or properties of the device, which may include, but is not limited or restricted to upload/download metrics (e.g., the amount of data uploaded and/or downloaded “throughput limits” for each connection, data transfer rate for each connection, etc.), the number (or percentage) of query messages including connection information that have returned a negative classification score (e.g., total number or percentage of failed lookups compared to total number of lookups for the device), or the like. Upon a monitored connection approaches (or exceeds) its operational limit, the POL connection tracker logic is configured to notify the POL decision logic to disable that connection, where the disablement may be temporary for a prescribed period of time or permanent unless disabled by the security team. The disablement may be conducted by Reset (RST) message transmission such as Transmission Control Protocol Reset (TCP RST) messages for example.

According to another embodiment of the disclosure, lieu of receiving connection information, the connection analytic logic (CAL) may be configured to receive and ingest log data associated with a monitored connection from a third-party service. In response to detection that the monitored connection is associated with a cyber threat, the POL decision logic may be configured to initiate signaling to the third-party service to disable the monitored connection.

According to yet another embodiment of the disclosure, the connection analytic logic (CAL) may be configured to receive connection information associated with a monitored connection. However, in addition to generating and transmitting the RST messages to disable the monitored connection, the POL decision logic may be configured to create firewall policy to block the monitored connection if considered to be associated with a cyber threat from a negative classification score that exceeds a prescribed threshold or the monitored connection approaching (or exceeding) an operational limit, as described above.

These and other features of the design provided herein can be better understood with reference to the drawings, description, and claims, all of which form the disclosure of this patent application. The technical advantages offered by the connection analytic logic working in combination with the classifier/POL model(s)/parser are numerous. For example, the connection analytic logic allows for detection of anomalous connections, which enables real-time (and faster) determination of cyber threats for the cyber threat has progressed. Other technical advances include, but are not limited or restricted to the following: (1) extending of respond actions to other protocols, not just TCP (e.g., this may be suitable for firewall-based actions; (2) avoids distributed denial of service (DDOS) attacks targeting POL lookups, where an attacker could make 1000s of unique connections that we would need to look-up with collecting the data on requests a device is making; (3) firewall-based actions are slower, but offload blocking connections from our TCP-based RST messages allows services to continue to detect and block new threats quickly, (4) apply POL actions in environments where we are unable to send RST messages, such as third-party zero trust platforms; and/or (5) limiting download sizes allows stop exfiltration of large amounts of data even to destinations that the user might normally go to.

These and other features of the design provided herein can be better understood with reference to the drawings, description, and claims, all of which form the disclosure of this patent application.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1A illustrates a block diagram of a first embodiment of a cyber threat detection system that includes a cyber security appliance implemented with connection analytic logic to protect operability of a scalable cloud platform and/or an enterprise network including multiple endpoint computing devices.

FIG. 1B illustrates a block diagram of a second embodiment of a cyber threat detection system that includes a cyber security appliance, cloud platform, and/or endpoint computing device(s) implemented with connection analytic logic to protect system operability.

FIG. 2 illustrates an exemplary embodiment of the physical architecture of the cyber security appliance of FIG. 1A including an optional virtual sensor (v-sensor) and components forming the connection analytic logic.

FIG. 3 illustrates an exemplary embodiment of the logical architecture of the cyber security appliance of FIG. 2 including components forming the connection analytic logic deployed as part of a network module and/or a cloud module.

FIG. 4 illustrates an exemplary embodiment of the logical architecture of an endpoint computing device installed with an endpoint agent (c-sensor) to monitor and/or collect connection information being telemetry data and communication data, and thereafter, provide the collection information to the connection analytic logic.

FIG. 5 illustrates a block diagram of an operational flow depicting operability of a sensor including a parser along with operability of the connection analytic logic in detecting an anomalous connection.

FIG. 6 illustrates a second embodiment of the cyber threat detection system that includes a cyber security appliance and/or a scalable cloud platform implemented with connection analytic logic to protect operability of an enterprise network through adjustment of third-party service and/or firewall operability.

FIG. 7A illustrates a block diagram of an operational flow depicting operability of the connection analytic logic in detecting a potential anomalous connection based on ingested telemetry data (log data) from a third-party service and issuing one or more messages to adjust operability (policy) of the third-party service to halt and block the potential anomalous connection.

FIG. 7B illustrates a block diagram of an operational flow depicting operability of the connection analytic logic in detecting a potential anomalous connection based on ingested telemetry data and analytics conducted on the telemetry data by the connection analytic logic and adjusting operability (policy) of a third party service and/or firewall to block a potential anomalous connection in addition to issuing reset messages to a computing device associated with a malicious source (threat actor).

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that one or more embodiments of the disclosure can be practiced without these specific details. In other instances, well-known components or methods have not been described in detail but rather in a block diagram in order to avoid unnecessarily obscuring the present design. Further, specific numeric references, such as a first computing device for example, have been made. However, the specific numeric reference should not be interpreted as a literal sequential order but rather interpreted that the first computing device may be different from a second computing device.

As set forth herein, the specific details are merely exemplary and for illustrative purposes. Hence, the features implemented in an embodiment may be implemented in another embodiment where logically possible. The specific details can be varied from and still be contemplated to be within the spirit and scope of the present system or component configuration.

### I. Terminology

In the following description, certain terminology is used to describe various features of the invention. For example, the terms “logic,” “module” and “component” are structures that can be implemented with electronic circuits, software stored in a non-transitory storage medium executed by one or more processors, and/or a combination of both. For instance, the logic (or module or component) may be representative of hardware, firmware or software that is configured to perform one or more functions. As hardware, a logic (or module or component) may include physical circuitry having data processing or storage functionality. Examples of such circuitry may include, but are not limited or restricted to a hardware processor (e.g., microprocessor with one or more processor cores, a digital signal processor, a graphics processing unit (GPU), a programmable gate array, a microcontroller, an application specific integrated circuit “ASIC,” etc.), a semiconductor memory, or combinatorial elements.

Alternatively, the logic (or module or component) may be software that includes code being one or more instructions, commands, or another data structure that, when compiled and/or processed (e.g., executed), perform a particular operation or a series of operations. Examples of software may include an application, a process, an instance, an Application Programming Interface (API), a routine, a subroutine, a plug-in, a function, an applet, a servlet, code, a script, a shared library/dynamic link library (dll), logical circuitry (e.g., logical functionality of the physical circuitry descried above), or one or more instructions. This software may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; non-persistent storage such as volatile memory (e.g., any type of random-access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the component (or module or logic) may be stored in persistent storage.

In general, the term “resource” generally relates to any logical or physical element that performs a specific task or function directed to managing security of a logical or physical network. Hence, a “cloud resource” relates to a logical element that performs a specific task or function within a cloud network. Examples of cloud resources may include, but are not limited or restricted to cloud-based components or services such as compute engines (e.g., AWSTM EC2, Azure® Azure® virtual machines, Google® compute engine, etc.), logical data stores (e.g., AWSTM S3, Azure® blob storage, etc.), policies, roles, users, certificates, virtual machines, network-based resources such as virtual private clouds (VPCs) or subnets, or the like.

The term “content” generally relates to a collection of information, whether in transit (e.g., over a network) or at rest (e.g., stored), often having a logical structure or organization that enables it to be analyzed by AI-based traffic analytics such as pattern-of-life (POL) model(s) or other types of cyber-threat detection and prevention components.

The term “networking device” should be generally construed as electronics with data processing capability and/or a capability of connecting to any type of network, such as a public network (e.g., Internet), a private network (e.g., a wireless data telecommunication network, a local area network “LAN,” etc.), or a combination of networks. A subset of networking devices is identified as a “computing device,” which may include, but are not limited or restricted to, the following: a server, a mainframe, a firewall, a router; or an endpoint (e.g., a laptop, a smartphone, a tablet, a desktop computer, a netbook, gaming console, a wearable, etc.), or the like. The term “endpoint computing device(s)” denotes one or more endpoint computing devices.

The term “interconnect” may be construed as a physical or logical communication path between two or more electronic devices or between different logic (engine or components). For instance, a physical communication path may include wired or wireless transmission mediums. Examples of wired transmission mediums and wireless transmission mediums may include electrical wiring, optical fiber, cable, bus trace, a radio unit that supports radio frequency (RF) signaling, or any other wired/wireless signal transfer mechanism. A logical communication path may include any mechanism that allows for the exchange of content between different logic.

The term “message” generally refers to signaling (wired or wireless) as either information placed in a prescribed format and transmitted in accordance with a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE; Instant Message Access Protocol (IMAP); or the like. Hence, each message may be in the form of one or more packets, frame, or any other series of bits having the prescribed, structured format. The term “computerized” generally represents that any corresponding operations are conducted by hardware in combination with software or firmware.

The character set “(s)” denotes one or more elements. For example, the term “network(s)” denotes one or more networks. For example, the term “classifier(s)” denotes one or more classifiers. As another example, the term “model(s)” denotes one or more models.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

### II. General Architecture

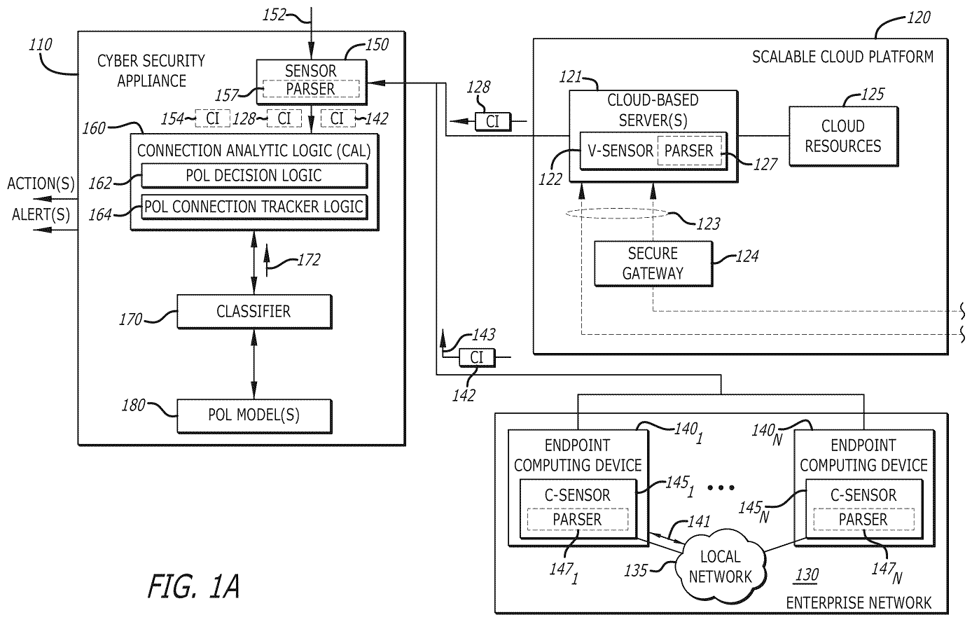

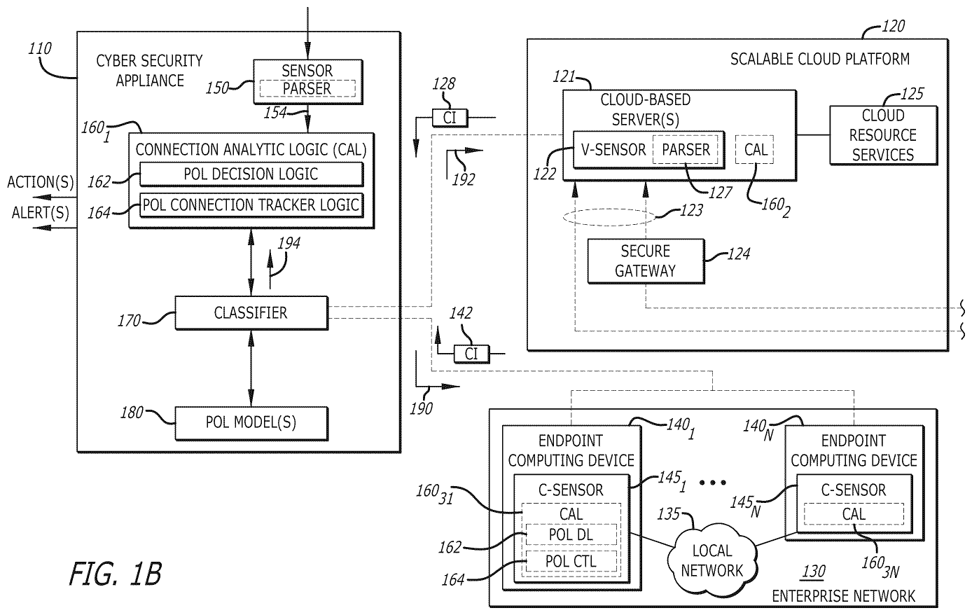

Referring to FIGS. 1A-1B, embodiments of a cyber threat detection system 100 are shown, which include a cyber security appliance 110 and/or a scalable cloud platform 120 configured to protect operability of an enterprise network 130 including multiple endpoint computing devices 1401-140N (N>1) communicatively coupled via a local network 135. Herein, the cyber security appliance 110 may be hosted in the enterprise network 130 (generally referred to as an on-premises (“on-prem”) deployment) or may be hosted separately and remotely from the enterprise network 130 as shown. For example, the cyber security appliance 110 may be accessible to the enterprise network 130 by a public or private network, or alternatively, the cyber security appliance 110 may be deployed as a component of the scalable cloud platform 120 (e.g., AWS®, AZURE®, etc.).

As shown in FIG. 1A, in a centralized deployment, the cyber security appliance 110 conducts analytics on connection information extracted from data traffic directed to the endpoint computing device(s) 1401-140N within the enterprise network 130 and cloud-based servers 121 within the cloud platform 120. For example, parsing logic 1471-147N (hereinafter, “parser”), installed at the endpoint computing device(s) 1401-140N, operating as a general point of network connection, extracts connection information (CI) 142 from data traffic 141 and routes the connection information 142 to connection analytic logic 160. The connection information 142 may include information concerning network connections to the endpoint computing device(s) 1401-140N, although it is contemplated that the connection information 142 may be expanded to be directed to other types of connections such as logical connections between different modules within the endpoint computing device(s) or cloud-based servers 121 within the cloud platform 120.

For FIG. 1A, the connection analytic logic 160 is configured to determine whether any of the monitored connections are anomalous and thereby constitute a cyber threat. For this embodiment, the connection analytic logic 160 may be configured to receive the connection information 142 from the parser 1471 and interact with a classifier 170, namely decision layer logic that may (i) perform a translation of the connection information into embedding data, (ii) perform a translation of embedding data from pattern-of-life (POL) model(s) 180 into a selected data structure, and/or (iii) guides interactions with the POL model(s) 180. In the following description, data translation will not be discussed to focus on inventive aspects of the disclosure.

However, as shown in FIG. 1B and described below, the analytics for determining threat levels of network connections are significantly handled in a decentralized manner in which connection analytic logic 160 may be deployed at each networking device (e.g., at cyber security appliance 110, at one or more cloud servers of the cloud platform 120, at one or more endpoint computing devices 1401-140N in the enterprise network 130, etc.). As an illustrative example, the parser 1471 may operate with a version of the connection analytic logic (CAL) 160 (e.g., CAL instance 16031) to provide the connection information 142 to the CAL instance 16031. The CAL instance 16031 interacts with the classifier 170 and the POL model(s) 180 to assign a classification score operating as an identifier representing the likelihood of the connection being associated with a cyber threat.

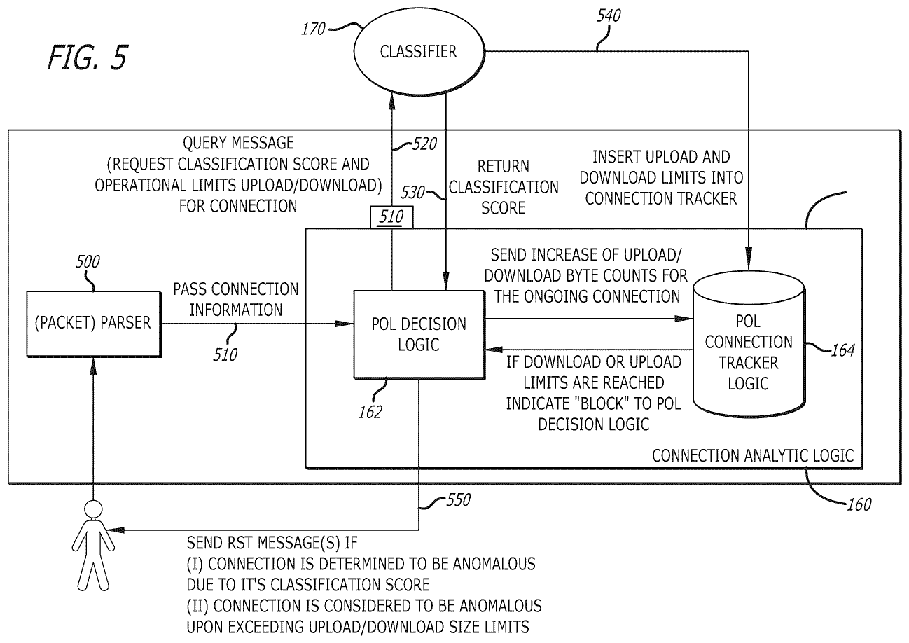

Both deployments will be described, although the operations will be highly related and illustrated in a logical representation in FIGS. 5 & 7A-7B.

### A. Centralized Deployment

Referring to FIG. 1A, within the enterprise network 130, one or more of the endpoint computing device(s) 140₁-140_{N} may be configured with an endpoint agent 145₁ . . . and/or 145_{N} (hereinafter, c-sensor 145₁-145_{N}). Herein, the c-sensor(s) 145₁-145_{N} are communicatively coupled to the cyber security appliance 110 to protect the endpoint computing devices 140₁-140_{N} from anomalous or malicious connections. Each of the c-sensor(s) 145₁-145_{N} is configured to ingest traffic data to monitor activity of the endpoint computing devices 140₁-140_{N}, namely monitor connections made with the endpoint computing devices 140₁-140_{N} that may include monitoring electronic mail (email) messaging.

According to one embodiment of the disclosure, the information associated with connections may be ascertained by extracting data from ingress messages into and egress messages from the endpoint computing devices 140₁-140_{N}. In particular, for this embodiment, each c-sensor (e.g., c-sensor 145₁) may be configured to extract information 142 associated with a connection with the endpoint computing devices 140₁ (hereinafter, “connection information 142”) from fields within message(s) propagating over the connection and then delivers the connection information 142 to the cyber security appliance 110 for processing. Examples of connection information 142 may include telemetry data that include network connection details, which may include one or more of the attributes listed below:

| FIELD NAME | |
|---|---|
| (Attribute) | DESCRIPTION |
| UID | Unique identifier for a connection |
| TS | Timestamp of start of connection |
| Source-IP | Source IP address |
| Dest_IP (or Dest | Destination IP address (or Hostname) |
| Hostname) | |
| Source_port | Source port number |
| Dest_port | Destination port number |
| Protocol | Transport protocol for the connection (TCP, UDP, |
| | etc.) |
| Connection_Status | Connection status (active, inactive, pending, etc.) |
| Orig_bytes | Number of bytes sent from device deemed the |
| | source of connection |
| Resp_bytes | Number of bytes sent from device deemed the |
| | destination of connection |

Besides ingesting ingress and egress network traffic, the c-sensor 145₁ installed on the endpoint computing device 140₁ may be configured to perform some processing on that network traffic before inclusion of the connection information 142 as part of a query message 143 to the cyber security appliance 110. The processing may be adapted to provide a message data structure recognized by a sensor 150 deployed within the cyber security appliance 110, which then extracts the connection information 142 from the query message 143 and forwards it to the connection analytic logic 160 for analysis.

As further shown in FIG. 1A, the cyber security appliance 110 is configured with the sensor 150 and the connection analytic logic 160. This sensor 150 functions as a traffic collection and analysis point, receiving data either from virtual network switches via SPAN or from host-based agents such as the c-sensors 145₁-145_{N} installed on virtual machines within the endpoint computing devices 140₁-140_{N} described above. The sensor 150 is configured to partially operate as a parser to extract the connection information 142 from an incoming message (e.g., query message 143) and forwards the connection information 142 to the connection analytic logic 160.

The connection analytic logic 160 is configured to assist in identifying deviations from normal behavior (e.g., unauthorized access attempts, data exfiltration activities, etc.) pertaining to connections to the endpoint computing device(s) 140₁-140_{N}, cloud server(s) 121, and/or the cyber security appliance 110 itself.

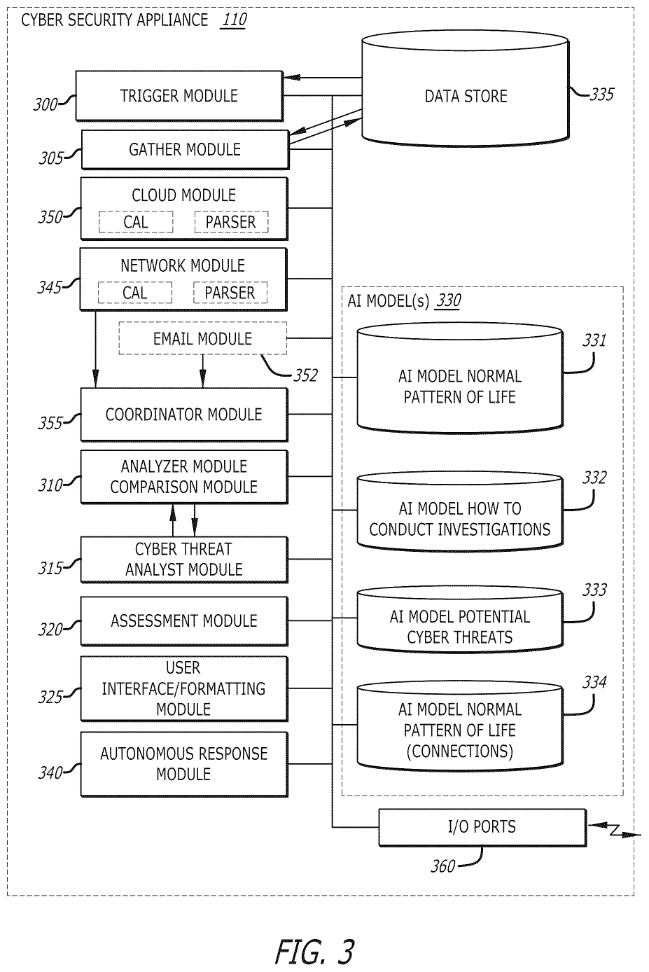

According to one embodiment of the disclosure, the connection analytic logic (CAL) 160 features pattern-of-life (POL) decision logic 162 and POL connection tracker logic 164. Both the POL decision logic 162 and the POL connection tracker logic 164 are communicatively coupled to the classifier 170, such as logic residing in the coordination module 255 of FIG. 3 for example. The classifier 170 is configured to formulate and utilize the POL model(s) 180 of a particular entity (e.g., user, device, group of users, group of devices, etc.) to identify connections that deviate from normal activity for the entity and generate a classification score 172, which operates as an identifier representing the likelihood of the connection being anomalous and potentially a cyber threat (e.g., insider threats, malware attack, data exfiltration, etc.). The classification score 172 is returned to the POL decision logic 162 and the POL connection tracker logic 164 to further monitor usage of the connection (e.g., determine if certain operational thresholds are met-data throughput, number of requests via the connection), where a ‘negative’ classification score (e.g., score with a first prescribed value or range of values) that may prompt generation of alert(s) and/or action(s) by the cyber security appliance 110 to disable or disconnect the connection.

More specifically, as shown in FIG. 1A, the parser 1471 within the c-sensor 145₁ may be configured to ingest raw data, such as network traffic data and optionally other telemetry data (e.g., log data, packet metadata, etc.) for example, and convert the raw data into structured information that CAL 160 maintained within modules of the cyber security appliance 110 (e.g., network module 345, cloud module 350, email module 352 of FIG. 3) can analyze. According to this embodiment of the disclosure, the parser 1471 is adapted to extract attributes and/or metrics from header(s) and/or payload of one or more messages propagating over a monitored connection. These attributes and/or metrics constitute the connection information 142, which may include source (IP) address, destination (IP) address, protocol type, source port, destination port, connection timestamp(s) as described above, along with any data that may assist in determining whether the connection is malicious or benign (e.g., session duration, etc.). This structured representation enables the sensor 150 to extract the connection information 142 for further analysis by the CAL 160, the classifier 170, and/or POL model(s) 180.

As shown, with the c-sensor 145₁, the parser 147₁ operates as a first stage of data refinement by at least extracting and structuring the connection information 142 into the query message 143 (normalized object) with consistent schema. The query message 143 may be securely transmitted to the cyber security appliance 110 for routing to the CAL 160 for analysis. According to this embodiment, the POL decision logic 162 receives the connection information 142 and evaluates the content of the connection information 142 to determine whether the connection has already been evaluated (e.g., evaluated with a prescribed time from a current time). If not, this connection information 142 (or a portion thereof) is directed to the POL model(s) 180, which are responsible for determination of the classification score 172 for the connection under evaluation.

The POL model(s) 180 operate by continuously ingesting telemetry data (e.g., attributes and metrics associated with the connection information 142) and comparing them against established baselines for a prescribed entity (e.g., each user, each user device, each group, or each device for the group of users). Using unsupervised learning and probabilistic scoring, the POL model(s) 180 assign the classification score 172 that reflects whether the monitored connection is anomalous, and the likelihood of the monitored connection being associated with a cyber threat. This classification score 172 is then evaluated by the POL decision logic 162, and if it exceeds a predefined threshold, signals the cyber security appliance 110 to take real-time action, which may include issuing alerts to security teams, executing TCP RST messages, or other containment measures to disrupt the suspicious connection before it can escalate into a breach. Also, the content may be used to assist in training of the POL model(s) 180 with connection data to later assist in determining whether the connection is benign, suspicious, or malicious.

Referring still to FIG. 1A, the POL connection tracker logic 164 is configured to receive and maintain state information associated with the monitored connection represented by the connection information 142 that is utilized by the c-sensors 145₁-145_{N}. The state information may include the amount of data uploaded and/or downloaded for a connection (throughput limits), data transfer rate, the number (or percentage) of connection analysis requests from the CAL 160 that have returned a negative classification score that denotes the connection may be associated with a cyber threat, or the like. Upon a connection approaching (or exceeding) one of its operational limits, the POL connection tracker logic 164 may notify the POL decision logic 162 to notify the autonomous response module 340 of FIG. 3 to disable the monitored connection through TCP RST message(s), notify a third-party service to disable the monitored connection, alter a firewall policy to block the connection, or the like.

Referring still to FIG. 1A, within the cloud platform 120, the v-sensor 122 is adapted to monitor data traffic 123 flowing through a secure gateway 124 and/or across other cloud ingress and/or egress points such as VPN tunnels, internal network segments, or the like. Normally deployed within the virtual network, the v-sensor 122 is positioned logically between the secure gateway 124 and cloud resources 125, the v-sensor 122 is a lightweight virtual probe designed for deployment in virtualized environments (hosted by the cloud platform 120) where physical probes are impractical. This placement allows the v-sensor 122 to observe east-west traffic inside the cloud platform 120 as well as north-south traffic passing through the secure gateway 124.

For this embodiment, the v-sensor 122 functions as another traffic collection and analysis point, where connection information 128 associated with the data traffic (e.g., packet headers, flow records, session metadata, etc.) may be extracted by parsing logic (parser) 127 from egress messages from and/or ingress messages into the cloud platform 120. Including telemetry data (e.g., attributes and/or metrics), the connection information 128 may be provided to the cyber security appliance 110 for routing to the CAL 160 for analysis. The CAL 160 may be the same logic used to conduct analytics on the connection information 142 from the c-sensors 145₁-145_{N} or may be different logic with similar functionality. For example, a first connection analytic logic may be configured to conduct analytics on the connection information 142 from the c-sensors 145₁-145_{N} while a second connection analytic logic may be configured to conduct analytics on the connection information 128 from the v-sensor 122. Both the first connection analytic logic and the second connection analytic logic would operate similarly, and may be configured to access the same or different POL models 180.

Referring still to FIG. 1A, within the cyber security appliance 110, the sensor 150 may be adapted with a parser (parsing logic) 157 to receive data traffic 152 from connections independent of the connections from the cloud platform 120 and the enterprise network 130 and extract the connection information 154 therefrom. The CAL 160 analyses the connection information 154, in a manner similar to its analysis of the connection information 128 and/or 142 as described above, where the classifier 170 and/or POL model(s) 180 may be relied upon to generate the classification score 172 associated with the connection information 154. The classification score 172 is used by the CAL 160 to determine initiation of alerts and/or actions or continue monitoring usage of the connection to identify if any operational limits are exceeded.

### B. Centralized Deployment

Referring now to FIG. 1B, a block diagram of a second embodiment of a cyber threat detection system 100 is shown. Herein, in lieu of deploying the CAL 160 being situated within the cyber security appliance 110 and in communication with the parser 147₁-147_{N} within each endpoint computing device 140₁-140_{N}, each endpoint computing device 140₁-140_{N} may be configured with c-sensor 145₁-145_{N} along with separation versions of the connection analytic logic 160 (hereinafter, CAL instances 160₃₁-160_{3N}). For example, the CAL 160₃₁ may include instances corresponding to the POL decision logic (POL DL) 162 and the POL connection tracker logic (POL CTL) 164, where the POL decision logic 162 receives the connection information 142 and evaluates the content of the connection information 142 locally at the endpoint computing device 140₁.

When the POL decision logic 162 determines that the connection has already been evaluated (e.g., evaluated with a prescribed time window), the POL decision logic 162 performs the same operations as before (e.g., monitors data usage, keeps the connection active if the classification score did not previously discover the connection was malicious). If the POL decision logic 162 determines that the connection has not been evaluated, the connection information 142 (or a portion thereof) is directed to the classifier 170 and POL model(s) 180 within the cyber security application 110. Thereafter, the classifier 170 is responsible for determining a classification score 190 associated with the monitored connection and returning the classification score 190 to the endpoint computing device 140₁.

Herein, the connection information may be processed locally in which (network) connection information 142 is provided to the cyber security appliance 110 to obtain a return message with the classification score 190 associated with the connection being evaluated. The classification score 190 corresponds to an identifier as to the likelihood of the connection being anomalous and potentially a cyber threat. Upon receipt of the classification score 190, the POL decision logic 162 can determine whether to prompt disconnection or disablement of the connection. Alternatively, the classification score 190 may cause the POL decision logic 162 to maintain the connection in an active state, where the POL connection tracker logic 164 monitors operability of the connection and notifies the POL decision logic 162 if any operational limits are met or exceeded (e.g., exfiltrated data exceeds a prescribed limit, a number of access requests made or denied, etc.).

Alternatively, it is contemplated that the c-sensor(s) 145₁-145_{N} may be communicatively coupled to the scalable cloud platform 120 to leverage operability of the connection analytic logic 1602 deployed therein to perform the operations described above.

As further shown in FIG. 1B, the cloud platform 120 may be configured with the v-sensor 122 along with the parser 127 and a version of the connection analytic logic 1602. According to one embodiment of the disclosure, the version of the connection analytic logic 1602 may correspond to local instances of the POL decision logic 162 and the POL connection tracker logic 164. The POL decision logic 162 extracts the connection information 128 from the data traffic 123 and evaluates the content of the connection information 128 locally at the connection analytic logic 1602. Upon determining that the connection has already been evaluated (e.g., evaluated with a prescribed time from a current time), the POL decision logic 162 and the POL connection tracker logic 164 continue to monitor connection usage and perform disconnection or disablement action when the usage exceeds operational limits. Where the POL decision logic 162 determines that the connection has not been evaluated, the connection information 128 (or a portion thereof) is directed to the classifier 170 and POL model(s) 180 within the cyber security application 110. Thereafter, the classifier 170 is responsible for determining a classification score 192 associated with the monitored connection at the cloud platform 120 and returning the classification score 192 to the connection analytic logic 1602 to cause or assisting in causing the disablement or disconnection of the monitored connection providing the data traffic 123 as described above.

Referring still to FIG. 1B, within the cyber security appliance 110, the sensor 150 may be adapted to monitor data traffic 152 from network connections independent of the connections from the cloud platform 120 and the enterprise network 130. Herein, the connection information 154 associated with the data (network) traffic 152 is analysed by the CAL 160₁, classifier 170 and/or POL model(s) 180 as described above. A classification score 194 for the connection information 154 is provided to the POL decision logic 162 within the CAL 160₁ when the connection information 154 determines what actions are performed by the cyber security appliance 110 (e.g., alerts, actions, none-await if operational limit violation, etc.).

### C. Physical Architecture—Cyber Security Appliance

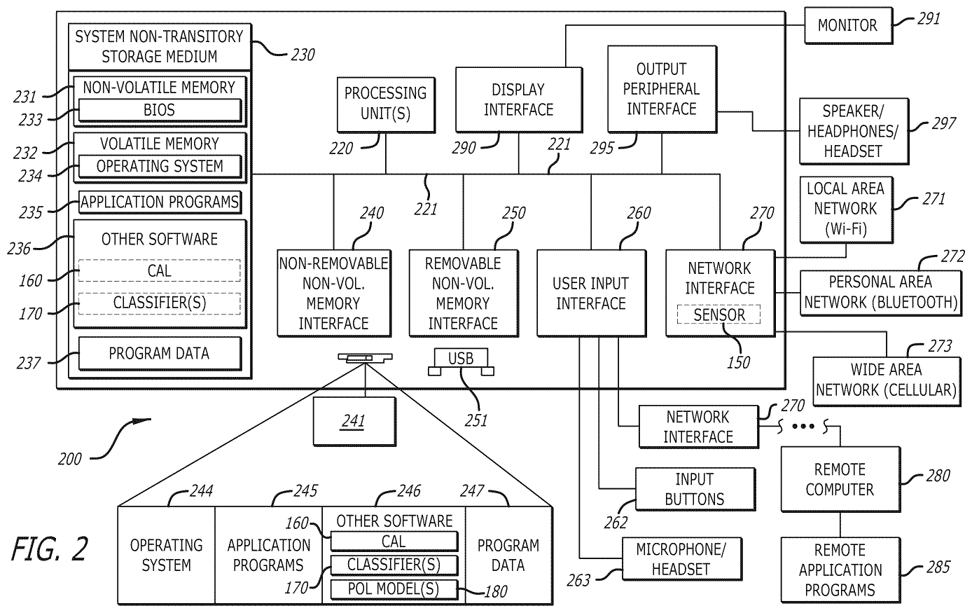

Referring now to FIG. 2, an exemplary embodiment of the physical architecture of the cyber security appliance 110 of FIGS. 1A-1B including an optional virtual sensor (v-sensor) and components forming the connection analytic logic (CAL) 160 is shown. The physical architecture may be representative of the hardware environment for the cyber security appliance 110 itself, which includes one or more processing units 220, a system non-transitory storage medium 230, a user input interface 260, a network interface 270, a display interface 290, and an output peripheral interface 295, all of which may be communicatively coupled via a system bus. The sensor 150 may be a physical sensor configured with parsing logic to extract connection information from an incoming message via the network interface 270 while the CAL 160 may be maintained in any type of non-transitory storage medium such as system non-transitory storage medium 230 or non-volatile storage device 241.

In various embodiments, the cyber security appliance 110 may include one or more processing units 220 configured to execute instructions. The one or more processing units 220 may have one or more processing cores and may be coupled to the system bus 221 that connects various system components, including the system non-transitory storage medium 230. The one or more processing units 220 may be responsible for executing the software instructions that constitute various logic of the cyber security appliance 110, such as data parsing, POL decision logic 162, POL connection tracker logic 164, or the like. The system bus 221 may be any of several types of bus structures, including a memory bus, an interconnect fabric, a peripheral bus, or a local bus using any of a variety of bus architectures.

The system non-transitory storage medium 230 may be configured to store information and instructions for execution by the one or more processing units 220. The system non-transitory storage medium 230 may include both volatile and non-volatile memory components to support the operations of the cyber security appliance 110. In the embodiment shown in FIG. 2, the system non-transitory storage medium 230 may include a non-volatile memory 231 and a volatile memory 232. These different types of memory may serve distinct functions within the overall architecture of the cyber security appliance 110.

In an embodiment, the non-volatile memory 231 may store firmware or other instructions that are used for the basic operation of the cyber security appliance 110. The non-volatile memory 231 may contain a basic input/output system (BIOS 233), which includes the fundamental routines that help to transfer information between elements within the cyber security appliance 110, particularly during the start-up sequence. Also, the non-volatile memory 231 could be configured to maintain the CAL 160.

The volatile memory 232 may be used for the temporary storage of data and program instructions that are actively being used or are about to be used by the one or more processing units 220. As shown in the embodiment, the volatile memory 232 may contain an operating system 234, one or more application programs 235, other software 236, and program data 237. As the volatile memory 232 allows for faster read and write access, which may be useful for the real-time performance of the cyber security appliance's analytical modules, the CAL 160 may be alternatively loaded and stored in the volatile memory 232.

The operating system 234 may manage the hardware and software resources of the cyber security appliance 110. It may provide common services for computer programs and may be responsible for tasks such as memory management, process scheduling, and controlling peripheral devices. The application programs 235 and other software 236 may run on top of the operating system 234.

The application programs 235 may, in an embodiment, represent the software modules of the cyber security appliance 110 described herein. For example, the code for a network module, cloud module or another type of module with POL decision logic 162, the POL connection tracker logic 164, or the autonomous response module could be loaded into the volatile memory 232 as one or more of the application programs 235 during execution. These programs may interact with the operating system 234 to access hardware resources and network services to perform their respective functions.

The other software 236 may include various other utilities, libraries, or background services that support the functioning of the operating system 234 and the application programs 235. This could include, for example, database management systems, communication protocols, cyber security analytics, or other foundational software components. These software modules may provide services that the application programs 235 rely on to perform their functions. It is contemplated that the connection analytic logic (CAL) 160 and/or classifier 170 may be installed therein.

The program data 237 may represent the dynamic data that is being processed or generated by the application programs 235. In the context of the cyber security appliance, the program data 237 could include the content of network connections under analysis, entity historical data retrieved from storage, or the like. This data may be stored in the volatile memory 232 for quick access by the one or more processing units 220.

The cyber security appliance 110 may also include one or more non-volatile storage devices for long-term data retention. A non-removable non-volatile memory interface 240 may be configured to connect to a primary storage device 241. This primary storage device 241 could be, for example, a solid-state drive (SSD) or a magnetic hard disk drive and may be used for persistent storage of the operating system, applications, and data.

In an embodiment, the primary storage device 241 may be used for long-term storage of an operating system 244, one or more application programs 245, other software 246, and program data 247. The contents of the primary storage device 241 may be loaded into the volatile memory 232 during operation. In certain embodiments, the data store of the cyber security appliance 110, which holds the historical data and AI-based POL model(s) 180, could reside on this primary storage device 241. It is contemplated that cyber security analytics logic, inclusive of the CAL 160, classifier 170 and/or POL model(s) 180, may be installed therein.

In addition to non-removable storage, the cyber security appliance 110 may include a removable non-volatile memory interface 250. This interface may be configured to read from and write to removable media, such as a USB flash drive or an external hard drive. This could be used for transferring data, installing software, or performing system maintenance and backups.

The removable non-volatile memory interface 250 may be connected to a physical port, such as a USB port 251. The USB port 251 provides a standardized interface for connecting a wide variety of peripheral devices to the cyber security appliance 110. The use of both removable and non-removable storage provides flexibility in how data and software are managed on the cyber security appliance 110.

A user may enter commands and information into the cyber security appliance 110 through a user input interface 260. This interface may be coupled to various input devices and may be responsible for translating the user's physical actions into digital signals that can be processed by the cyber security appliance 110. This allows for human interaction with the system, which is one aspect of the security mailbox assistant module workflow. For example, a user may utilize an input device to initiate the submission of a suspicious communication for further analysis.

The user input interface 260 may be connected to one or more input buttons 262. These input buttons 262 could be part of a standard keyboard, a mouse, or a custom control panel on the cyber security appliance 110 itself. An analyst might use these buttons to navigate the user interface, select communications for investigation, or confirm autonomous response actions prompted by the connection analytic logic (CAL) 160. An end-user might also use these input buttons 262 to interact with a client application to initiate a disconnection (e.g., TCP Reset message) or temporarily disable a port associated with a network connection based on findings by the CAL 160.

The user input interface 260 may also be connected to a microphone/headset 263. In an embodiment, the microphone/headset 263 could be used for voice commands, allowing an analyst to interact with the system using natural language. It could also be used for communication purposes, such as participating in an audio call during an incident response. This component could also be used to record audio notes or annotations associated with a particular security investigation.

The cyber security appliance 110 may provide output to a user through various peripheral devices. A display interface 290 may be configured to connect to a monitor 291. The monitor 291 may be used to display the graphical user interface of the cyber security appliance 110, allowing an analyst to view alerts, investigate threats, and configure the system. The display interface 290 may be responsible for rendering the graphical elements and data, such as the deterministic narrative report generated by the security mailbox assistant module, for presentation to the user.

An output peripheral interface 295 may be configured to connect to other output devices. For example, it may connect to a speaker/headphones/headset 297 for providing audible alerts or notifications to the user. This could be particularly useful for signaling critical alerts that require immediate attention from a security analyst. These audible alerts could be customized based on the severity or type of the detected threat. These various output mechanisms allow the system to communicate information to the user through multiple sensory channels, ensuring that important information is conveyed effectively.

The cyber security appliance 110 may operate in a networked environment using a network interface 270. The network interface 270 may be configured to establish a communication link with other computing devices and may be responsible for formatting data for transmission over a network and for decoding data received from the network. This interface can be configured for the cyber security appliance 110 to monitor network traffic and is useful for the operation of the data loss prevention architecture, as it manages the reception and transmission of communications within the mail flow loop.

The network interface 270 may support various types of network connections. This can include a local area network (LAN) 271, which could be a wired Ethernet network or a wireless Wi-Fi network. It could also include a personal area network (PAN) 272, such as a Bluetooth network for connecting to nearby peripherals. Furthermore, it could include a wide area network (WAN) 273, such as a cellular network, for communication over long distances.

When operating in a networked environment, the cyber security appliance 110 may connect to a remote computer 280. The remote computer 280 could be a server, another client device, or any other network node. In an embodiment, the remote computer 280 could host a centralized management console or a cloud-based portion of the cybersecurity service, with which the local appliance communicates.

In an embodiment, portions of the cyber security appliance 110 could be distributed, with some modules running on the local cyber security appliance 110 and others running as remote application programs 285 on the remote computer 280. This distributed architecture may be common in cloud-based or enterprise-wide deployments, allowing for scalable and resilient operation. The ability to interact with remote application programs 285 is known by those skilled in the art as a feature of a modern, interconnected system.

Although a specific embodiment for a generic computing device for conducting the various steps, processes, methods, and operations described herein is discussed with respect to FIG. 2, any of a variety of systems and/or devices may be utilized in accordance with embodiments of the disclosure. For example, the cyber security appliance 110 could be implemented on a high-performance server cluster with multiple processing units and large amounts of memory to manage the analysis of a large enterprise network.

### D. Logical Architecture—Cyber Security Appliance

Referring now to FIG. 3, an exemplary embodiment of the logical architecture of the cyber security appliance of FIG. 2 including components forming the connection analytic logic deployed as part of the network module and/or the cloud module. The AI-based cyber security appliance 110 is configured to protect the enterprise, including but not limited to its customer cloud environments, from cyber threats. Various logic and components, such as AI-based models and modules of the cyber security appliance 110, cooperate to protect the customer cloud environment under analysis from cyber threats.

According to an embodiment of the disclosure, the AI-based cyber security appliance 110 may include a trigger module 300, a (data) gather module 305, an analyzer module 310, a cyber threat analyst module 315, an assessment module 320, a formatting module 325, one or more AI models 330, a data store 335, an autonomous response module 340, network module 345, cloud module 350, an optional email module 352, and/or a coordinator module 355. Herein, the AI model(s) 330 are trained with machine learning on (i) a normal pattern of life (POL) for entities in the network/domain/cloud under analysis, notably connection behaviours or patterns, (ii) cyber threat hypotheses to form and investigate a cyber threat hypothesis on what are a possible set of cyber threats and their characteristics, symptoms, remediations, etc., and/or (iii) possible cyber threats.

The cyber security appliance 110 is configured to protect a network/cloud from a cyber threat (insider attack, malicious files, malicious emails, etc.). In an embodiment, the cyber security appliance 110 can protect all of the devices on the network(s)/domain(s)/cloud environment(s) being monitored based on activity, for example, on an individual basis from monitoring communications going to and from the computing device on the network and/or cloud resources 140 within the cloud environment 20 of FIGS. 1A-1B. For example, via I/O ports 360, the network module 345 may communicate with network sensors (e.g., c-sensor(s), v-sensor(s), physical sensor(s)) to monitor network connections. The steps below will detail the activities and functions of several of the components in the cyber security appliance 110.

The gather module 305 may have a series of one or more process identifier classifiers, which may operate as part of or in combination with the connection analytic logic (CAL) in the network module 345, the cloud module 350 and/or the email module 352. A process identifier classifier can identify and track each process and device in the network or the cloud environment, under analysis, making communication connections. The data store 335 may be configured to cooperate with the process identifier classifier to collect and maintain historical data of processes and their connections, which is updated over time as the network is in operation. In an example, the process identifier classifier can identify each process running on a given device along with its endpoint connections, which are stored in the data store.

The analyzer module 310 is configured to cooperate with AI model(s) 330 or other modules in the cyber security appliance 110 to confirm a presence of a cyber threat attacking one or more domains in an organization's system and/or one or more cloud resources within a cloud environment. A cyber threat analyst module 315 is configured to cooperate with the AI model(s) 330 and/or other modules in the cyber security appliance 110 to conduct a long-term investigation and/or a more in-depth investigation on potential cyber threats attacking domain(s) and/or cloud environment in the enterprise security system 105. An algorithm in the analyzer module 310 can cooperate with the gather module 305 to collect any additional data and metrics to support a possible cyber threat hypothesis. The analyzer module 310 and/or the cyber threat analyst module 315 can also look for other anomalies, such as model breaches, including, for example, deviations for a normal behavior of an entity, and other techniques discussed herein. The analyzer module 310 and/or the cyber threat analyst module 315 can cooperate with the AI model(s) 330 trained on potential cyber threats in order to assist in examining and factoring these additional data points that have occurred over a given timeframe to see if a correlation exists between 1) a series of two or more anomalies occurring within that time frame and 2) possible known and unknown cyber threats. The cyber threat analyst module 315 can cooperate with the internal data sources as well as external data sources to collect data in its investigation.

The cyber threat analyst module 315 in essence allows two levels of investigations of potential cyber threat attacks. In a first level, the analyzer module 310 and AI model(s) 330 can rapidly detect and then autonomously respond to overt and obvious cyber threats. However, thousands to millions of low level anomalies, including anomalous connections, occur in a domain or cloud environment under analysis all of the time; and thus, most other systems need to set the threshold of trying to detect a cyber threat at level higher than the low level anomalies examined by the cyber threat analyst module 315 just to not have too many false positive indications of a cyber threat attack when one is not actually occurring, as well as to not overwhelm a human cyber analyst receiving the alerts with so many notifications of low level anomalies that they just start tuning out those alerts. However, advanced persistent threats attempt to avoid detection by making these low-level anomalies in the system over time during their attack before making their final coup de grâce/ultimate mortal blow against the domain or cloud environment being protected. The cyber threat analyst module 315 conducts investigations over time that can detect these advanced persistent cyber threats actively trying to avoid detection by looking at one or more of these low-level anomalies as a part of a chain of linked information.

The cyber threat analyst module 315 is configured to form and investigate hypotheses on what are a possible set of cyber threats and can also cooperate with the analyzer module 310 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 330 trained with machine learning on the normal pattern of life of entities in the system. The cyber threat analyst module 315 may be configured to submit to check and recheck various combinations/a chain of potentially related information under analysis until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted; and thus, needs a human to further investigate the anomaly of interest included in the chain of potentially related information.

It is contemplated that a data analysis process or any analytics can be conducted by algorithms/scripts to perform their function discussed herein; and can in various cases use AI classifiers as part of their operation. It is further contemplated that any portions of the AI-based cyber security appliance 110 or the cyber security system, when implemented as software, can be stored in one or more non-transitory memory storage devices in an executable format to be executed by one or more processors.

Again, an input from the cyber threat analyst module 315 of a supported hypothesis of a potential cyber threat will trigger the analyzer module 310 to compare, confirm, and act on that cyber threat. In contrast, the cyber threat analyst module 315 is configured to investigate subtle indicators and/or initially seemingly isolated unusual or suspicious activity such as a worker is logging in after their normal working hours or a simple system misconfiguration has occurred. Most of the investigations conducted by the cyber threat analyst module 315 on unusual or suspicious activities/behavior may not result in a cyber threat hypothesis that is supported but rather most are refuted or simply not supported. Typically, during the investigations, several rounds of data gathering to support or refute the long list of potential cyber threat hypotheses formed by the cyber threat analyst module 315 may occur before the algorithms in the cyber threat analyst module 315 determines whether a particular cyber threat hypothesis is supported, refuted, or needs further investigation by a human. The rounds of data gathering build chains of linked low-level indicators of unusual activity along with potential activities that could be within a normal pattern life for that entity to evaluate the whole chain of activities to support or refute each potential cyber threat hypothesis formed. The investigations by the cyber threat analyst module 315 can happen over a relatively long period of time and be far more in depth than the analyzer module 310 which will work with the other modules and AI model(s) 330 to confirm that a cyber threat has in fact been detected.

The gather module 305 may further extract data from the data store 335 at the request of the cyber threat analyst module 315 and/or analyzer module 310 on each possible hypothetical threat that would include the abnormal behavior or suspicious activity and then can assist to filter that collection of data down to relevant points of data to either 1) support or 2) refute each particular hypothesis of what the cyber threat, the suspicious activity and/or abnormal behavior relates to. The gather module 305 cooperates with the cyber threat analyst module 315 and/or analyzer module 310 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

The cyber threat analyst module 315 is configured to form and investigate hypotheses on what are a possible set of cyber threats and can cooperate with the analyzer module 310 with the one or more data analysis processes to confirm the results of the investigation on the possible set of cyber threats hypotheses that would include the at least one of i) the abnormal behavior, ii) the suspicious activity, and iii) any combination of both, identified through cooperation with the AI model(s) 330 trained with machine learning on the normal pattern of life of entities in the domains or cloud-based resources (customer cloud environment) under analysis.

Likewise, as further shown in FIG. 3, the gather module 305 and the analyzer module 310 cooperate to supply further data and/or metrics requested by the analyzer module 310 when attempting to support or rebut each cyber threat hypothesis. Again, the analyzer module 310 can cooperate with the other modules and AI model(s) 330 to rapidly detect and then autonomously respond to overt and obvious cyber threat attacks, (including ones found to be supported by the cyber threat analyst module 315).

As a starting point, the cyber security appliance 110 can use the trigger module 300 working with the AI model(s) 330 of the normal pattern of life for the entities in the network/domain or the cloud resources or cloud architectures in the cloud platform under analysis to identify anomalous activity associated with network connections utilized by an entity compared to the normal activity with respect to network connectivity for that entity. The content associated with the anomalous activity may be supplied to the analyzer module 310 and/or the cyber threat analyst module 315. The analyzer module 310 and/or the cyber threat analyst module 315 may also receive other inputs such as AI model breaches, AI classifier breaches, etc. Note, the trigger module 300 can also receive a trigger to start an investigation from an external source.

Many other model breaches of the AI model(s) 330 trained with machine learning on the normal behavior of the system and/or cloud environment (or resources/architectures thereof) can send an input into the cyber threat analyst module 315 and/or the trigger module 300 to trigger an investigation to start the formation of one or more hypotheses on what are a possible set of cyber threats that could include the initially identified abnormal identified abnormal behavior and/or suspicious activity. Note, a deeper analysis can look at example factors such as i) how long has the component, such as a cloud resource for example existed or is registered; ii) what kind of certificate is the communication using; etc.

Note, the cyber threat analyst module 315 in the cyber security appliance 110 provides an advantage as it reduces the time taken for human led or cybersecurity investigations, provides an alternative to manpower for small organizations and improves detection (and remediation) capabilities within the cyber security appliance 110.

The cyber threat analyst module 315 that forms and investigates hypotheses on what are the possible set of cyber threats can to use hypotheses mechanisms including any of 1) AI model(s) 330 trained on how human cyber security analysts conduct an investigation on a possible set of cyber threats hypotheses that would include at least an anomaly of interest, 2) one or more scripts outlining how to conduct an investigation on a possible set of cyber threats hypotheses that would include at least the anomaly of interest, 3) one or more rules-based models on an investigation on a possible set of cyber threats hypotheses how to conduct an investigation on a possible set of cyber threats hypotheses that would include at least the anomaly of interest, and 4) any combination of these. Again, the AI model(s) 330 may use supervised machine learning and/or unsupervised learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses.

Referring still to FIG. 3, the autonomous response module 340 is configured to take one or more autonomous mitigation actions to mitigate the cyber threat associated with anomalous connections. The autonomous response module 340 can reference an AI model trained to track a normal pattern of life for each entity to perform an autonomous act of, for example, restricting connectivity resource or cloud architecture having i) an actual indication of compromise and/or ii) merely adjacent to a known compromised networking device, to merely take actions that are within that resource's or cloud architecture's normal pattern of life to mitigate the cyber threat.

The chain of the individual alerts, activities, and events that form the pattern including one or more unusual or suspicious activities into a distinct item for cyber threat analysis of that chain of distinct alerts, activities, and/or events. The cyber threat analyst module 315 may reference the one or more machine learning models trained on, in this example, cloud architecture threats to identify similar characteristics from the individual alerts and/or events forming the distinct item made up of the chain of alerts and/or events forming the unusual pattern. In the next step, the assessment module 320 with the AI classifiers, once armed with the knowledge that malicious activity is likely occurring/is associated with a given process from the analyzer module 310, then cooperates with the autonomous response module 340 to take an autonomous action such as i) deny access in or out of the computing device or the network ii) shutdown activities involving a detected malicious agent, iii) restrict computing devices and/or user's to merely operate within their particular normal pattern of life, iv) adjust access roles associated with the cloud architecture and/or certain cloud resources such as remove some user privileges/permissions associated with the compromised cloud account, and/or v) conduct offensive countermeasures to disable operations of a malicious server responsible for the malicious activity, such as a cyber threat or an on-going cyberattack.

The autonomous response module 340, rather than a human taking an action, can be configured to cause one or more rapid autonomous actions in response to be taken to counter the cyber threat, which may include disabling a source of the cyber threat (e.g., malicious server(s)). The disabling of the malicious server may be accomplished by disabling its ability to communicate with targeted systems.

### III. Endpoint Agent: C-Sensor

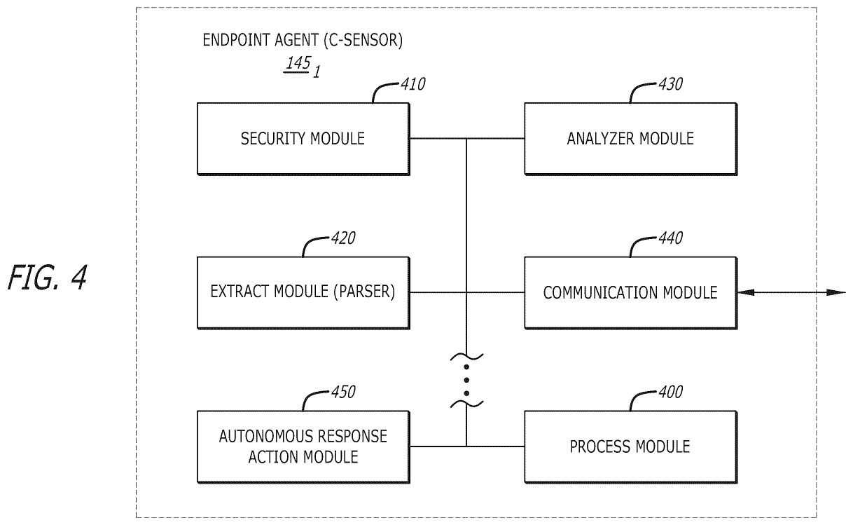

FIG. 4 illustrates an exemplary embodiment of the logical architecture of an endpoint agent (e.g., c-sensor 145₁ of FIGS. 1A-1B) installed on an endpoint computing device (e.g., endpoint computing device 140₁) to monitor and/or collect telemetry data (connection information 142) associated with a network device, and thereafter, provide the collected connection information 142 to the connection analytic logic (CAL) 160. Herein, FIG. 4 depicts an exemplary c-sensor 145₁ and the one or more modules utilized by the c-sensor 145₁.

According to one embodiment of the disclosure, the c-sensor 145₁ may comprise a process module 400 configured to monitor processes operating and resident on the endpoint computing device as a first set of process data, and a security module 410 having an interface to cooperate with and integrate with an operating system (OS) of the endpoint computing device. The c-sensor 145₁ may also include an extract module 420 configured to detect and extract the connection information 142 associated with ingress (incoming) messages into and egress (outgoing) messages from the endpoint computing device 140₁. The c-sensor 145₁ may optionally include an analyzer module 430 with connection analytic logic to analyze the connection information 142 along with a communication module 440 to send the connection information 142 securely to a classifier on the cyber security appliance 110. Lastly, as discussed in greater detail in FIG. 3, the c-sensor 145₁ may have an autonomous action module 450 configured to perform autonomous action(s) that are correlated to initiating actions and/or alerts in response to the classification of the monitored connection as anomalous.

The c-sensor 145₁, by extending visibility to endpoint computing devices even when they are disconnected from the network, enables the cyber threat defense system to cover branch offices and remote workers working on endpoint computing devices off the network (such as an organization's virtual private networks (VPNs). In addition, a light version of the c-sensor 145₁ can be employed in an endpoint computing device such as an IoT device that has less computing power than an endpoint computing device of a laptop computing device. As such, the c-sensor 145₁ can be deployed on a range of managed endpoint computing devices. This, therefore, allows the systems to analyze real-time network traffic, for example, of remote workers working on an endpoint device, in the same way the cyber security appliance 110 analyzes network traffic and its metadata in its network by correlating a web of connections to develop an evolving understanding of workforce behavior. Furthermore, the c-sensors 145₁-145_{N} described herein provide much-needed visibility of suspicious connectivity to the endpoint computing devices 140₁-140_{N}.

Referring now to FIG. 5, an exemplary diagram of an operational flow depicting operability of a sensor including a (packet) parser 500 along with operability of the connection analytic logic (CAL) 160 in detecting an anomalous connection is shown. In response to receipt of data traffic (e.g., series of messages) over a network connection, the parser 500 is configured to identify and extract information associated with the network connection (hereinafter, “connection information”). Thereafter, the connection information 510 is provided to the CAL 160, namely the POL decision logic 162. The POL decision logic 162 is configured to determine if the network connection, identified by the connection information 510, has already been analyzed by the CAL 160. If so, provided that the analysis of the network connection was recent (e.g., within a prescribed time window) and the network connection has not been classified as malicious, the network connection remains active. Otherwise, the POL decision logic 162 issues a query message 520 to the classifier 170, where the query message 520 requests a classification score for the connection and upload/download operational limits to assist the POL connection tracker logic 164 to ensure that these limits have not been reached to denote a potential cyber threat.

The classifier 170 is adapted to (i) receive the connection information 510 including the query message 520 and (ii) leverage the POL models to determine whether the connection is considered a normal connection for a particular entity under review (e.g., user, single device, group of users, or group of devices, etc.). This determination results in a classification score 530 (e.g., classification score 172 of FIG. 1A or classification scores 190/192/194 of FIG. 1B) may be based on multiple factors such as (i) how common a connection is for that device, based on the destination IP and/or the ports/protocol used in the connection, and/or (ii) how common a connection is for a given group where the device in question device has been classified as a member that group. The classification score 530 for the network connection is returned to the POL decision logic 162 while the operational limits 540 (e.g., upload/download byte limits, etc.) are provided to the POL connection tracker logic 164.

Upon receiving the classification score 530 associated with the network connection, the POL decision logic 162 is configured to cause transmission of TCP RST message(s) 550 if one of two conditions occurs. The first condition is that the connection is deemed to be anomalous due to its classification score being equal to or exceeding a prescribed value to denote a high likelihood of the connection is associated with a cyber threat. The second condition is that the connection is considered anomalous due to its operation exceeds an operational limit. For example, the upload/download byte size (e.g., total byte size for connection session) exceeds an upload or download limit. As another example, the source IP address has been associated with a prescribed number of connections with ‘negative’ classification scores (i.e., classification scores below a prescribed value limit to denote anomalous). Otherwise, the network connection remains active.

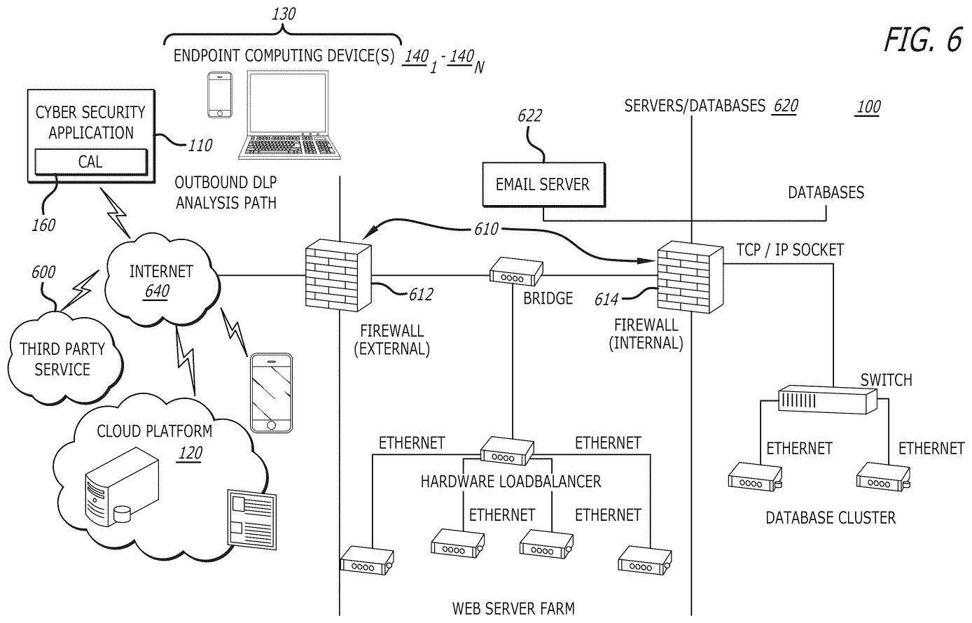

Referring to FIG. 6, an illustrative embodiment of the cyber threat detection system 100 is shown, where the cyber threat detection system 100 features the cyber security appliance 110 implemented with the connection analytic logic (CAL) 160 to protect operability of the cloud platform 120 and/or the enterprise network 130 through an adjustment in the operability of a third-party service 600 and/or firewall(s) 610. Herein, the cyber security appliance 110 may be configured to monitor, analyze, and enforce actions on electronic communications to protect a network environment from cyber threats. The cyber security appliance 110 may be implemented as a physical appliance, a virtual appliance, or as a cloud-based service that is communicatively coupled to the network.

As depicted in the embodiment shown in FIG. 6, the cyber security appliance 110 may be positioned to observe traffic within the intranet, including communications originating from or directed to the one or more endpoint computing devices 140₁-140_{N}, and servers/databases 620 (e.g., email server(s), instant messaging server(s), etc.). The cyber security appliance 110 may be configured to perform various analyses as described herein, such as data parsing, connection information extraction, POL model analyses, to identify anomalous or malicious connections that deviate from an established pattern of normal or expected connections for the entity as measured by the POL models.

In certain embodiments, the cyber security appliance 110 may build and maintain a dynamic, ever-changing model of the ‘normal behavior’ or ‘pattern of life’ for each user and device within the system. This approach may be based on probabilistic mathematics and can involve monitoring a wide array of interactions, events, and communications within the system, such as which computer is communicating with which other computer, what types of files are being created, and which networks are being accessed. By establishing a bespoke ‘pattern of life’ for each entity, the cyber security appliance 110 can spot behavior that seems to fall outside of this normal pattern and flag this behavior as anomalous, potentially requiring further investigation or an autonomous response action.

The one or more endpoint computing devices 140₁-140_{N} may represent the various computing devices used by individuals within the organization to conduct their daily tasks. In an embodiment, the endpoint computing device(s) 140₁-140_{N} can include, but are not limited to, laptops, desktop computers, smartphones, and tablets. These devices may serve as the primary origination point for outbound communications and/or the final destination for inbound communications that are analyzed by the cyber security appliance 110.

The network environment may further include connectivity to external resources via the Internet 640. The Internet 640 may serve as the primary conduit for communications entering and leaving the organization's private network. The cyber security appliance 110 may be configured to monitor traffic flowing to and from the Internet 640 to detect threats such as phishing attacks, command-and-control communications, or attempts at data exfiltration. The analysis of communications may involve examining the reputation of external domains, the structure of URLs, and other characteristics of traffic passing through the network's perimeter.

In an embodiment, the network may include access to a cloud platform 120. The cloud platform 120 may host a wide range of services, applications, and data storage used by the organization. This can include infrastructure-as-a-service, platform-as-a-service, and software-as-a-service (SaaS) applications. The cyber security appliance 110 may be configured to extend its monitoring and protection capabilities to the cloud platform 120, analyzing API calls, data transfers, and user activities within the cloud environment to ensure a consistent security posture across both on-premises and cloud-based resources.

The network environment may also include the email server 622. The email server 622 may be configured to manage the sending, receiving, and storing of email communications for the organization. In an embodiment, the CAL 160 deployed in the cyber security appliance 110 may cooperate with the email server 622 to analyze connection information pertaining to connections providing inbound and outbound messages in real-time via monitoring and analyzing the email traffic. This analysis may involve comparing the content of the email messages against a user's historical lexical profile to detect shifts or anomalous connections that utilize the email server 622.

The internal network may be segmented for security purposes, for example, by using one or more firewalls 610 such as a first firewall (external) 612 and a second firewall (internal) 614 to create one or more demilitarized zones (DMZ). These firewalls 612/614 may be configured to inspect and filter traffic based on a set of security rules, controlling access with the Internet 640. Communications may pass through these firewalls 612 and/or 614 via a TCP/IP socket, which provides a standard endpoint for network communication. The cyber security appliance 110 may analyze the data packets traversing these TCP/IP sockets to perform its various security functions. In certain embodiments, a network bridge may be used to connect different network segments, and a hardware load balancer may be used to distribute traffic efficiently across multiple servers, such as those in a web server farm.

The overall architecture depicted in FIG. 6 provides a comprehensive view of a modern enterprise network. The placement and configuration of the cyber security appliance 110 within this environment allows it to have broad visibility into a wide range of communication channels and user activities. This visibility is foundational to the system's ability to build accurate ‘pattern of life’ models and to detect the subtle deviations that may indicate a sophisticated cyber threat.

In an embodiment, the cyber security appliance 110 may use unsupervised machine learning to continuously learn and adapt its understanding of what constitutes normal behavior. This allows the cyber threat detection system 100 to remain effective even as the organization's environment changes, without requiring constant manual tuning or updates of static rules. The cyber threat detection system 100 can learn “on the job” from the real-world data it observes, constantly refining its models to become more bespoke and accurate over time.

The cyber threat detection system 100 may also be configured to take a variety of autonomous response actions when a threat is detected. These actions may be surgical and proportionate to the detected threat, aiming to neutralize the threat while minimizing disruption to the business. For example, instead of blocking an entire connection, the system might just preclude transmissions with payloads exceeding a prescribed byte count.

In various embodiments, the network environment shown in FIG. 6, therefore, can serve as the operational domain for a sophisticated, AI-driven cyber security platform. The platform can be configured to protect against a wide range of threats by understanding the unique ‘pattern of life’ of the organization and detecting subtle deviations from that norm across multiple communication vectors, including email and/or cloud services.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory machine-readable storage devices in an executable format to be executed by one or more processors. The computer-readable storage medium may be non-transitory and does not include radio or other carrier waves. The computer readable storage medium could be, for example, a physical computer readable storage medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with an embodiment. Components of the computing system can include, but are not limited to, a processing unit having one or more processing cores, a system memory, and a system bus that couples various system components including the system memory to the processing unit.

Although a specific embodiment for the network environment is described above with respect to FIG. 6, any of a variety of systems and/or processes may be utilized in accordance with embodiments of the disclosure. For example, the cyber security appliance 110 may be implemented as a distributed software solution running on existing servers within the network environment rather than as a dedicated physical or virtual appliance. Additionally, the networking environment may include a different number of devices and connections and those skilled in the art will recognize that this layout is exemplary and not instructional. The elements depicted in FIG. 6 may also be interchangeable with other elements of FIGS. 1A-5 as required to realize a particularly desired embodiment.

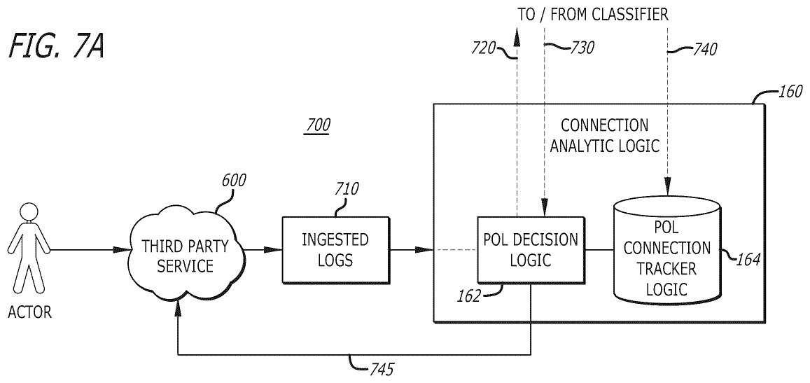

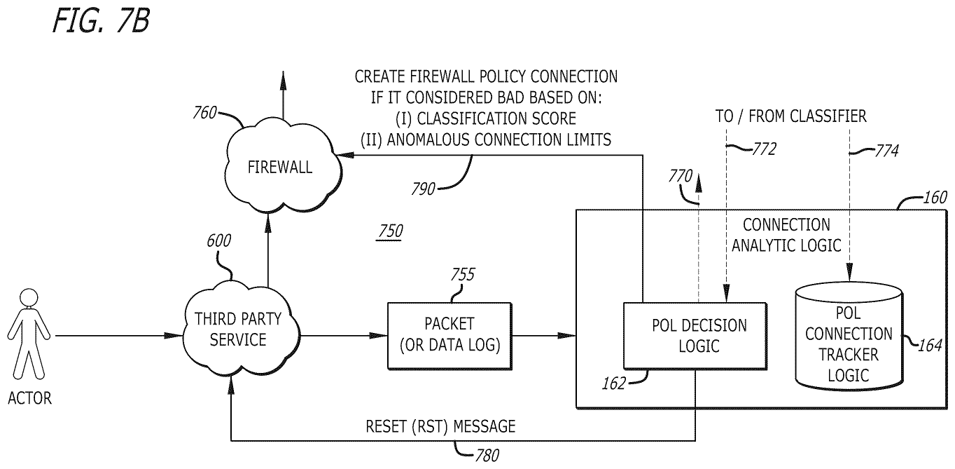

Referring to FIG. 7A, an illustrative diagram of an operational flow 700 depicting operability of the connection analytic logic (CAL) 160 in detecting a potential anomalous connection is shown. The detection of the potential anomalous connection may be based on ingested telemetry data (e.g., log data) 710 from the third-party service 600 in lieu of actual data traffic extracted from sensors and parsed by parsing logic as the actual data is unavailable to the CAL 160. Herein, at least a portion of the log data 710 is analyzed by the POL decision logic 162, which determines if the log data 710 has been evaluated previously. If not, connection information 720 acquired from the log data 710 is provided to the classifier and POL model(s) for analysis and return of a classification score 730. The operational limits 740 associated with the connection are provided to the POL connection tracker logic 164. In response to a classification score 730 that denotes the log data 710 is associated with an anomalous connection (or operational limits are exceeded as monitored by the POL connection tracker logic 164 as described for FIG. 5), the POL decision logic 162 may provide message(s) 745 to the third-party service 600 to adjust its operability (policy) to halt and block the potential anomalous connection.

Referring now to FIG. 7B, an illustrative diagram of an operational flow 750 depicting operability of the connection analytic logic in detecting a potential anomalous connection and leveraging functionality of a firewall 760 is shown. Herein, the detection of the potential anomalous connection may be based on ingested telemetry data (log data) 755 from the third-party service 600 in which connection information 770 extracted from the log data 755 is provided to the classifier and POL model(s) for analysis. In response to retrieval of a classification score 772 from the classifier that denotes the log data is associated with an anomalous connection (or operational limits 774 provided to the POL connection tracker logic 164 have been exceeded, the POL decision logic 162 may issue a Reset (RST) message 780 to the third-party service 600 to prompt signaling to disable or disconnect communications with a computing device associated with a malicious source (threat actor) to disable the connection. The POL decision logic 162 may further provide one or more messages 790 to the firewall 760 to create the firewall policy to block the connection in response to a ‘negative’ classification score or the connection exceeds its operational limits (e.g., upload or download limits are exceeded).

### IV. AI-Based Pol Model Training

In step 1, an initial training of the AI-based POL model trained on connection-based cyber threats can occur using unsupervised learning and/or supervised learning on characteristics and attributes of known potential cyber threats including malware, insider threats, and other kinds of cyber threats that can occur within that domain. Each AI-based POL model can be programmed and configured with the background information to understand and handle particulars, including different types of data, protocols used, types of devices, user accounts, etc. of the system being protected. The AI-based POL model can all be trained on the specific machine learning task that they will perform when put into deployment. For example, the AI-based POL model, such as POL model(s) 180 or example (hereinafter “POL model(s) 180”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the AI model(s) 180 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 110, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the POL model(s) 180 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain to establish an initial normal behavior for entities in the network/domain under analysis.

Thus, a deployed Artificial Intelligence model 180 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of one or more Artificial Intelligence models 180 trained with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of one or more Artificial Intelligence models trained on a normal pattern of life of entities in the system can occur. Initial training of one or more Artificial Intelligence models trained with machine learning on a behavior of the pattern of life of the entities in the network/domain can occur where each type of network and/or domain will generally have some common typical behavior with each model trained specifically to understand components/devices, protocols, activity level, etc. to that type of network/system/domain. What is normal behavior of each entity within that system can be established either prior to deployment and then adjusted during deployment or alternatively the model can simply be placed into an observation mode for an initial week or two when first deployed on a network/domain to establish an initial normal behavior for entities in the network/domain under analysis. During deployment, what is considered normal behavior will change as each different entity's behavior changes and will be reflected using unsupervised learning in the model such as various Bayesian techniques, clustering, etc. The POL model(s) 180 can be implemented with various mechanisms such neural networks, decision trees, etc, and combinations of these. Likewise, one or more supervised machine learning POL model(s) 180 may be trained to create possible hypotheses and perform cyber threat investigations on agnostic examples of past historical incidents of detecting a multitude of possible types of cyber threat hypotheses previously analyzed by human cyber security analyst. More on the training of POL model(s) 180 are trained to create one or more possible hypotheses and perform cyber threat investigations will be discussed later.

At their core, the self-learning POL model(s) 180 that model the normal behavior (e.g. a normal pattern of life) of entities in the network mathematically characterizes what constitutes ‘normal’ behavior, based on the analysis of a large number of different measures of a device's network behavior-packet traffic and network activity/processes including server access, data volumes, timings of events, credential use, connection type, volume, and directionality of, for example, uploads/downloads into the network, file type, packet intention, admin activity, resource and information requests, command sent, etc.

### V. Clustering Methods

In order to model what should be considered as normal for a device or cloud container, its behavior can be analyzed in the context of other similar entities on the network. The POL model(s) 180 can use unsupervised machine learning to algorithmically identify significant groupings, a task which is virtually impossible to do manually. To create a holistic image of the relationships within the network, the POL model(s) and AI classifiers may employ several different clustering methods, including matrix-based clustering, density-based clustering, and hierarchical clustering techniques. The resulting clusters can then be used, for example, to inform the modeling of the normative behaviors and/or similar groupings.

The OL model(s) and classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning POL model(s) are trained to create possible hypotheses and how to perform cyber threat investigations on agnostic examples of past historical incidents of detecting a multitude of possible types of cyber threat hypotheses previously analyzed by human cyber threat analysis. POL model(s) trained on forming and investigating hypotheses on what are a possible set of cyber threats can be trained initially with supervised learning. Thus, these POL model(s) can be trained on how to form and investigate hypotheses on what are a possible set of cyber threats and steps to take in supporting or refuting hypotheses. The POL model(s) trained on forming and investigating hypotheses are updated with unsupervised machine learning algorithms when correctly supporting or refuting the hypotheses including what additional collected data proved to be the most useful. More on the training of the POL model(s) that are trained to create one or more possible hypotheses and perform cyber threat investigations will be discussed later.

Next, the various Artificial Intelligence models and AI classifiers combine use of unsupervised and supervised machine learning to learn ‘on the job’-it does not depend upon solely knowledge of previous cyber threat attacks. The Artificial Intelligence models and classifiers combine use of unsupervised and supervised machine learning constantly revises assumptions about behavior, using probabilistic mathematics, which is always up to date on what a current normal behavior is, and not solely reliant on human input. The Artificial Intelligence models and classifiers combine use of unsupervised and supervised machine learning on cyber security is capable of seeing hitherto undiscovered cyber events, from a variety of threat sources, which would otherwise have gone unnoticed.

Next, these cyber threats can include, for example, Insider threat—malicious or accidental, Zero-day attacks—previously unseen, novel exploits, latent vulnerabilities, machine-speed attacks—ransomware and other automated attacks that propagate and/or mutate very quickly, Cloud and SaaS-based attacks, other silent and stealthy attacks advance persistent threats, advanced spear-phishing, etc.

All of the above POL model(s) 180 can continually learn and train with unsupervised machine learning algorithms on an ongoing basis when deployed in their system that the cyber security appliance 110 is protecting. Thus, learning and training on what is normal behavior for each user, each device, and the system overall and lowering a threshold of what is an anomaly.

### VI. Anomaly Detection/Deviations

Anomaly detection can discover unusual data points in your dataset. Anomaly can be a synonym for the word ‘outlier.’ Anomaly detection (or outlier detection) is the identification of rare items, events or observations which raise suspicions by differing significantly from a majority of the data. Anomalous activities can be linked to some kind of problems or rare events. Since there are tons of ways to induce a particular cyber-attack, it is difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous. The AI unsupervised learning model learns patterns from the features in the day-to-day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two-level analysis on anomalous behavior and determine correlations.

In an example, 95% of data in a normal distribution lies within two standard-deviations from the mean. Since the likelihood of anomalies in general is extremely low, the modules cooperating with the AI model of normal behavior can say with high confidence that data points spread near the mean value are non-anomalous.

In reality, the cyber security appliance 110 should not flag a data point as an anomaly based on a single feature. Merely, when a combination of all the probability values for all features for a given data point is calculated can the modules cooperating with the AI model of normal behavior can say with high confidence whether a data point is an anomaly or not.

Again, the POL model(s) trained on a normal pattern of life of entities in a network (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. U.S. Pat. No. 10,701,093 granted Jun. 30, 2020, titled “Anomaly alert system for cyber threat detection” constitutes an example Bayesian probabilistic approach, which is incorporated by reference in its entirety. In addition, US Patent Publication No. 2021/0273958 filed Feb. 26, 2021, titled “Multi-stage anomaly detection for process chains in multi-host environments” operates as another exemplary anomalous behavior detector using a recurrent neural network and a bidirectional long short-term memory (LSTM), which is incorporated by reference in its entirety. In addition, US Patent Publication No. 2020/0244673, filed Apr. 23, 2019, titled “Multivariate network structure anomaly detector,” which is incorporated by reference in its entirety, constitutes another exemplary anomalous behavior detector with a Multivariate Network and Artificial Intelligence classifiers.

The cyber security appliance 110 in a computer builds and maintains a dynamic, ever-changing model of the ‘normal behavior’ of each user and machine within the system. The approach is based on Bayesian mathematics, and monitors all interactions, events, and communications within the system.

The methods, apparatuses, and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory computer readable mediums in an executable format to be executed by one or more processors. The computer readable medium may be non-transitory and does not include radio or other carrier waves. The computer readable medium could be, for example, a physical computer readable medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. Likewise, a component may be implemented in hardware electronic circuits, software components, and a combination of both. A machine learning model is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A computerized method for analyzing connections with pattern-of-life (POL) models to determine whether a connection is anomalous, comprising:
receiving information associated with a connection;
conducting analytics on the connection information using at least a POL model of the POL models to determine whether the connection is anomalous;
assigning a negative classification score to the connection in response to the POL model determining that the connection is anomalous; and
disconnecting or disabling the connection in response to receiving the negative classification score assigned to the connection.

2. The computerized method of claim 1, wherein the connection is a network connection.

3. The computerized method of claim 1, wherein prior to receiving the information, the computerized method further comprising:
parsing one or more messages routed over the connection to identify the connection information;
extracting the connection information;
determining, by POL decision logic, whether the connection information has been previously evaluated; and
routing the connection information to be received by a classifier, wherein the classifier selects the POL model to process the connection information.

4. The computerized method of claim 3, wherein the POL decision logic is configured to conduct operations of disconnecting or disabling the connection in response to receiving the negative classification score from the classifier.

5. The computerized method of claim 1, wherein the assigning of the negative classification score to the connection further comprises determining operational limits associated with the connection and routing the operational limits to POL connection tracker logic operating with POL decision logic to disconnect or disable the connection in response to receiving a positive classification score and the operational limits have been exceeded.

6. The computerized method of claim 1, wherein prior to receiving the information, the computerized method further comprising:
parsing log data received from a third-party service to identify the connection information;
extracting the connection information; and
routing the connection information to be received by a classifier in response to the connection information has not been previously evaluated by POL decision logic, the classifier selects the POL model to process the connection information.

7. The computerized method of claim 6, wherein the disconnecting or disabling of the connection includes providing a message to the third-party service to disconnect or disable the connection.

8. The computerized method of claim 7, wherein the disconnecting or disabling of the connection further includes providing a message to a firewall to alter a policy to prevent re-establishment of the connection.

9. A non-transitory storage medium storing software in an executable format that, when executed by one or more processing units, is configured to operate with a classifier and one or more pattern-of-life (POL) models to determine whether a connection is anomalous, the software comprising:
POL decision logic configured to (i) receive information associated with a connection directed to a networking device, (ii) determine whether the connection has been previously evaluated, (iii) provide the connection information to a classifier for routing and processing by a POL model of the POL models, wherein the POL model analyzes the connection information to determine whether the connection is anomalous, (iv) receive a classification score that identifies whether the connection is anomalous or normal, and (v) generate one or more messages to disable or disconnect the connection to the networking device; and
POL connection tracker logic configured to (i) receive data associated with operational limits associated with the connection from the classifier operating with the POL model, (ii) monitor the connection to detect if the operational limits associated with the connection are exceeded, and (iii) notify the POL decision logic to generate the one or more messages to disable or disconnect the connection to the networking device when the operational limits have been exceeded.

10. The non-transitory storage medium of claim 9, wherein the software further comprising a parser communicatively coupled to connection analytic logic including the POL decision logic and the POL connection tracker logic, the parser to identify and extract the connection information from content within one or more messages propagating over the connection.

11. The non-transitory storage medium of claim 9, wherein the POL decision logic is configured to generate the one or more messages to disable or disconnect the connection to the networking device in response to receiving the classification score having a prescribed value that identifies the connection is anomalous.

12. The non-transitory storage medium of claim 9, wherein the POL connection tracker logic signals the POL decision logic to disconnect or disable the connection in response to the classification score being set to a value that identifies the connection is normal and the POL connection tracker logic determines that the operational limits have been exceeded.

13. A cyber threat detection system comprising:
a pattern-of-life (POL) model to conduct analyses on information associated with a connection to determine whether the connection is anomalous; and
a connection analytic logic configured to identify whether the connection has been previously evaluated, route the connection information to the POL model for processing, wherein the connection analytic logic is configured to disable or disconnect the connection in response to a classification score, generated by the POL model, represents that the connection is anomalous, where when any of the POL model and the connection analytic logic are implemented in software, then that software is stored in one or more non-transitory storage mediums in an executable format to be executed by one or more processing units.

14. The cyber threat detection system of claim 13, wherein the connection analytic logic is further configured to (i) receive operational limits associated with the connection from the POL model after processing of the connection information and (ii) disable or disconnect the connection in response to a classification score, generated by the POL model, represents that the connection is normal and the operational limits are currently being exceeded by the connection.

15. The cyber threat detection system of claim 13, wherein the connection analytic logic comprises
POL decision logic configured to (i) receive connection information, (ii) determine whether the connection has been previously evaluated, (iii) provide the connection information to a classifier for routing and processing by the POL model that analyzes the connection information to determine whether the connection is anomalous, (iv) receive the classification score that identifies whether the connection is anomalous or normal, and (v) generate one or more messages to disable or disconnect the connection; and
POL connection tracker logic configured to (i) receive data associated with operational limits associated with the connection from the classifier operating with the POL model, (ii) monitor the connection to detect if the operational limits associated with the connection are exceeded, and (iii) notify the POL decision logic to generate the one or more messages to disable or disconnect the connection when the operational limits have been exceeded.

16. The cyber threat detection system of claim 15 further comprising a parser communicatively coupled to the POL decision logic, where the parser to identify and extract the connection information from content within one or more messages propagating over the connection.

17. The cyber threat detection system of claim 15, wherein the POL connection tracker logic signals the POL decision logic to disconnect or disable the connection in response to the classification score being set to a value that identifies the connection is normal and the POL connection tracker logic determines that the operational limits have been exceeded.

18. The cyber threat detection system of claim 13, wherein the connection analytic logic is configured to disable or disconnect the connection in response to the classification score having a prescribed value that identifies the connection is anomalous.

19. The cyber threat detection system of claim 13, wherein the connection analytic logic is configured to disable or disconnect the connection by at least providing a message to a third-party service to disconnect or disable the connection.

20. The cyber threat detection system of claim 13, wherein the connection analytic logic is configured to disable or disconnect the connection by at least providing a message to a firewall to alter a policy to prevent re-establishment of the connection.
